(19) United States
(12) Patent Application Publication
(10) Pub. No.: US 2002/0084614 A1
(43) Pub. Date: Jul. 4, 2002

(54) Structure for mounting shock abosorber and spring to suspension apparatus

(76) Inventor: Dong-Kee Chun, Suwon-City (KR)

Correspondence Address: Pennie & Edmonds, LLP, 3300 Hillview Avenue, Palo Alto, CA, 94304, US

(21) Appl. No.: 10/033,449

(22) Filed: Dec. 27, 2001

(30) Foreign Application Priority Data
Dec. 29, 2000 (KR) 2000-85855

(51) Int. Cl. B60G 15/07

(52) U.S. Cl. 280/124.147

(57) ABSTRACT

A structure for mounting a shock absorber and a spring in a suspension apparatus wherein the top of the spring is connected with the shock absorber in an integral module and the bottom of the spring is supported against a wheel support member, thereby securing a smooth operational state for the shock absorber to improve riding comfort of a vehicle and the durability of the shock absorber.

### BACKGROUND OF THE INVENTION

The present invention relates to a suspension apparatus, and more particularly to a structure for mounting a shock absorber and a spring onto a rear wheel suspension apparatus.

In general, a top portion of a shock absorber 5 is connected with a top portion of a spring 4 via a cap 7. A spring seat 6 supporting a bottom of the spring 4 is then fixed at the external cylindrical surface of the shock absorber 5. As described above, at the upper part of the structure, the shock absorber 5 and spring 4 are bolted through cap 7 to a part of the car body. At the lower part of the structure, the bottom of the shock absorber 5 is connected with a wheel support member, such as a lower control arm or torsion beam axle.

In a suspension apparatus thus constructed, relative movement of the car wheel and car body is buffered and absorbed by the spring 4 and shock absorber 5 for greater riding comfort. The shock absorber 5 and the spring 4 are compressed and extended by the relative movement of the car wheel and body as shown in FIG. 5. If the shock absorber 5 and spring 4 are compressed, the spring 4 is eccentrically compressed by a jolt of the shock absorber. When the spring 4 is eccentrically compressed, there occurs a difference in the resilience of the spring 4 on opposite sides. The shock absorber 5 thus undergoes a bending force exerted by the spring as shown in FIG. 6. Due to the bending force acting on the shock absorber 5, irregular contact between internal wall surfaces of the shock absorber and its piston occur, thereby increasing the friction and reducing the durability of the shock absorber 5 and degrading car riding comfort.

Also, because of the many different forces applied to the shock and spring, and to resist the bending forces described, a hard bushing is typically required to provide sufficient durability. A hard bushing, however, has a negative impact on vibration.

### SUMMARY OF THE INVENTION

According to the present invention, a structure for mounting a shock absorber and a spring in a suspension apparatus is provided. The structure prevents the shock absorber from experiencing bending force due to eccentric resilience of the spring when the shock absorber and spring are jolted by relative movement of the car body and wheel. The present invention thus maintains the shock absorber in a smooth operational state to improve vehicle riding comfort and durability of the shock absorber. Moreover, the bottom of the shock absorber supports only its own load, not the load applied on the spring, and can more efficiently control vibration with a softer bushing material.

In a preferred embodiment, the top of the spring is connected to the shock absorber in an integral module, and the bottom of the spring is supported against a wheel support member. Also, the bottom of the spring is supported against the wheel support member via a spring seat, and the bottom of the shock absorber is connected with the spring seat.

According to an alternative preferred embodiment, a cap member receives a shock absorber having top and bottom ends. The shock absorber top end is connected to the cap member. A spring having top and bottom ends surrounds the shock absorber, with its top end being also connected to the cap member. A spring seat is connected to the shock absorber bottom end and the bottom end of the spring bears against the spring seat. The spring seat is fixed to a wheel support member, which may be a lower control arm connecting member or a torsion beam. Preferably, the wheel support member includes a ring-shaped part to receive the spring seat and the cap member is an inverted, cone-shaped cup.

### BRIEF DESCRIPTION OF THE DRAWINGS

Objects and aspects of the invention will become apparent from the following description of preferred embodiments with reference to the accompanying drawings in which:

FIG. 1 is a perspective view of a shock absorber and a spring module in accordance with the present invention;

FIG. 2 is a perspective view of a torsion beam, shock absorber and spring where the module is mounted in accordance with an embodiment of the present invention;

FIG. 3 is a perspective view of a lower control arm connecting member, where the shock absorber and spring module is mounted in accordance with an alternative embodiment of the present invention;

FIG. 4 schematically illustrates an operational state of a suspension apparatus in accordance with the present invention;

FIG. 5 schematically illustrates an operational state of a conventional suspension apparatus to describe problems of the prior art; and

FIG. 6 is a schematic view illustrating the load applied to a shock absorber according to a conventional embodiment of the prior art.

### DETAILED DESCRIPTION OF THE INVENTION

Hereinafter, a preferred embodiment of the present invention will be described in detail with reference to accompanying drawings.

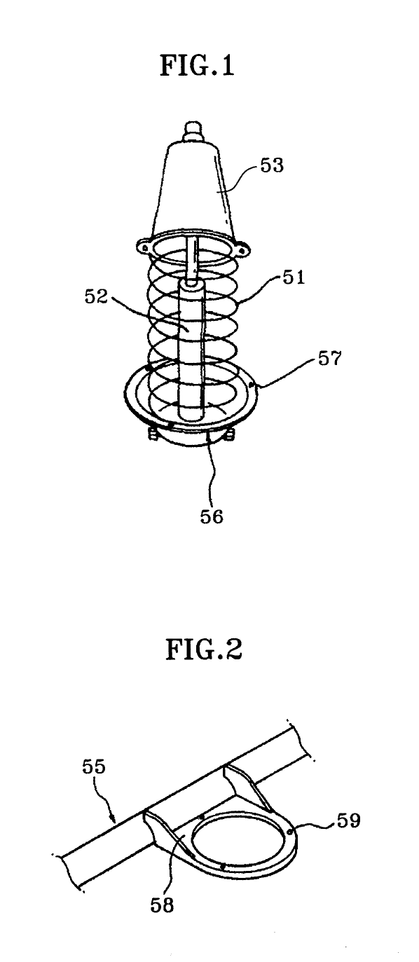

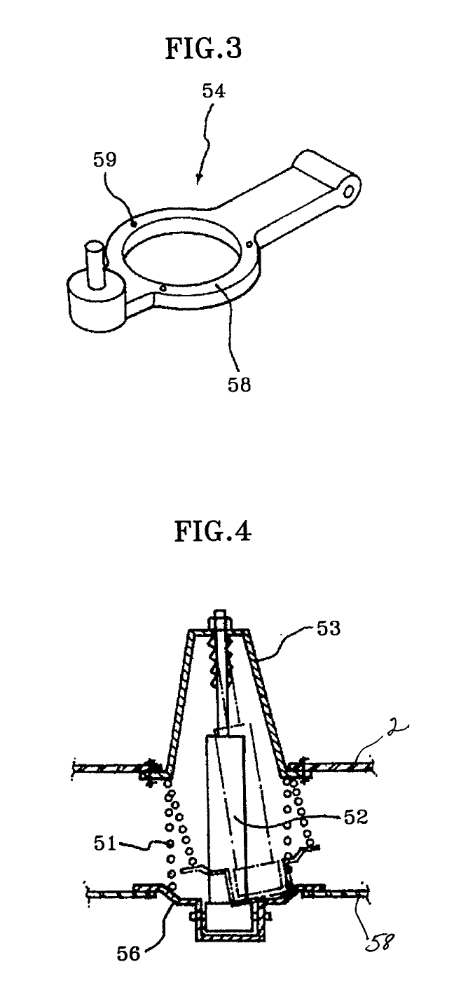

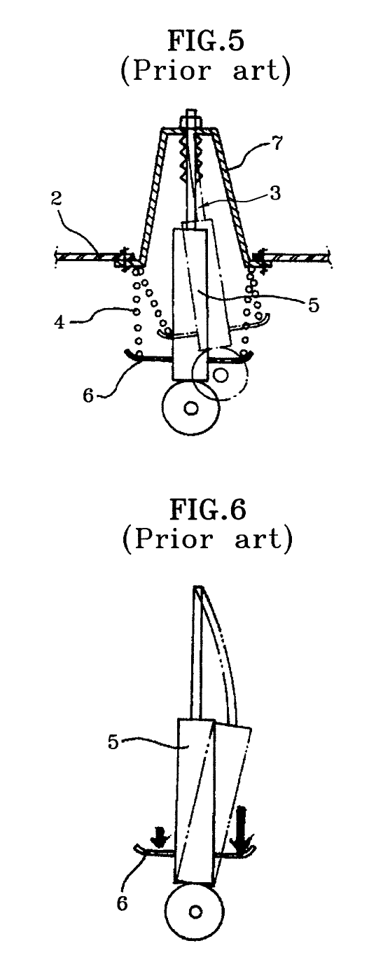

As shown in FIG. 1, the top of spring 51 is connected with a shock absorber 52 through a cap 53 in an integral module. The bottom of the spring 51 is supported against, for example, a lower control arm connecting member 54 or a torsion beam 55 connected with the lower control arm that functions as a wheel support member. Thus, spring 51 connected with the shock absorber 52 through cap 53, forms an integral module that provides ease of handling. As explained below, this also permits the bottom of spring 51 to be directly coupled with the wheel support member and not to an external cylindrical surface of the shock absorber.

The bottom of the spring 51 is supported against a lower control arm connecting member 54, i.e., a wheel support member, and/or a torsion beam 55, also a wheel support member. Spring seat 56 includes a plurality of bolt holes 57. A ring-shaped accommodating part 58 is formed on the lower control arm connecting member 54, and the torsion beam 55, for accommodating the spring seat 56. A plurality of holes 59 are provided to match the bolt holes 57 for convenient assembly. The bottom of the shock absorber 52 is connected to the floor surface of the spring seat 56. As such, eccentrically acting forces of spring 51 do not influence the shock absorber 52, but are directly transmitted to the wheel support member. As a result, the shock absorber 52 can include a softer material as a bushing material because the eccentric bending force exerted by spring 51 is isolated from the bottom of the shock absorber 52. Thus, the construction according to the invention is more effective in controlling vehicle vibration.

The operational effect of the present invention thus constructed is described below. If relative movement occurs, as shown in FIG. 4, spring 51 provides a different resilience at both sides of the shock absorber 52 due to its different degrees of transformation, to thereby generate bending force. However, the bending force is transmitted only to the wheel support member through spring seat 56 and accommodating part 58, not to the shock absorber 52.

Therefore, the shock absorber 52 demonstrates its unique feature, thereby securing the riding comfort of a vehicle and significantly improving its durability. Because the bending force caused by the eccentric compression of the spring 51 is not transmitted to the shock absorber 52, the bottom of the shock absorber 52 can be connected with the vehicle support member by a bushing having a degree of durability great enough to support against the load applied to the shock absorber 52. A bushing made of a material softer than the conventional one is utilized to be more advantageous in controlling vehicle vibration.

As described above, there are advantages in the present invention in that it is possible to prevent the shock absorber from being affected by the bending force generated by the eccentric resilience of the spring in a relative movement of the car body and wheel, thereby maintaining its operational state and improving its durability and the riding comfort of the vehicle. The bottom of the shock absorber supports the load applied only by the shock absorber, not the eccentric load of the spring, thereby making it possible to utilize a softer material for the bushing to effectively control vehicle vibrations.

What is claimed is:

1. A structure for mounting a shock absorber and a spring in a suspension apparatus with the top of the spring being connected with the shock absorber in an integral module and with the bottom of the spring being supported against a wheel support member.

2. The structure, as defined in claim 1, wherein the bottom of the spring is supported against the wheel support member via a spring seat, and the bottom of the shock absorber is connected with the spring seat.

3. The structure, as defined in claim 2, wherein the wheel support member is a torsion beam and an accommodating part is formed for the spring seat.

4. The structure, as defined in claim 2, wherein the wheel support member is a lower control arm connecting member connected to a lower control arm with an accommodating part for the spring seat.

5. A vehicle suspension assembly, comprising:
a cap member;
a shock absorber having top and bottom ends, the top end connected to the cap member;
a spring having top and bottom ends surrounding the shock absorber, its top end being also connected to the cap member;
a spring seat connected to the shock absorber bottom end, bottom end of the spring bearing against the spring seat; and
a wheel support member, wherein said spring seat is fixed to said wheel support member.

6. The vehicle suspension assembly according to claim 5, wherein said wheel support member comprises a lower control arm connecting member of a torsion beam.

7. The vehicle suspension assembly according to claim 6, wherein said wheel support member includes a ring-shaped accommodating part receiving the spring seat.

8. The vehicle suspension assembly according to claim 5, wherein the cap member comprises an inverted, cone-shaped cup.
